(19) United States
(12) Patent Application Publication
(10) Pub. No.: US 2007/0028256 A1
(43) Pub. Date: Feb. 1, 2007

(54) Method and apparatus for facilitating program selection

(75) Inventor: Tomohiro Azami, Kanagawa-ken (JP)

Correspondence Address: LOUIS WOO;LAW OFFICE OF LOUIS WOO, 717 NORTH FAYETTE STREET, ALEXANDRIA, VA, 22314, US

(73) Assignee: Victor Company of Japan, Ltd., Yokohama (JP)

(21) Appl. No.: 11/490,097

(22) Filed: Jul. 21, 2006

(30) Foreign Application Priority Data
Jul. 29, 2005 (JP) 2005-221706
May 24, 2006 (JP) 2006-143826

(51) Int. Cl. H04H 9/00; G06F 3/00; G06F 13/00; H04N 7/16; H04N 5/445

(52) U.S. Cl. 725/13; 725/9; 725/46

(57) ABSTRACT

Keywords are extracted from program information pieces corresponding to broadcast programs. Calculation is made as to the degrees of user's preference for the extracted keywords respectively. A keyword-operation history reflects user's choice of one among the extracted keywords which is carried out to select one from the broadcast programs. Calculation is made as to the degrees of user's interest in the extracted keywords respectively in response to the keyword-operation history. The calculated preference degrees of the extracted keywords are updated into new calculated preference degrees in response to the calculated interest degrees of the extracted keywords. The extracted keywords are arranged in the order of new calculated preference degree. Among the arranged keywords, a prescribed number of successive keywords starting from one having the highest new calculated preference degree are selected as preferred keywords. The preferred keywords are presented to the user.

### BACKGROUND OF THE INVENTION

1. Field of the Invention

This invention relates to a method and an apparatus for facilitating the selection of television programs. In addition, this invention relates to a computer program for facilitating the selection of television programs.

2. Description of the Related Art

Broadcast systems such as “satellite broadcasting” and “terrestrial digital broadcasting” provide a multitude of channels each having a lot of television programs. A user of a television receiver can select one from the television programs. As the number of broadcasted television programs increases, it is more difficult for the user to comprehensively grasp what television programs are being broadcasted. When broadcasted television programs are so many, the user has some trouble in finding favorite one. In addition, there is a greater chance that the user may be unaware of the broadcasting of a favorite program and miss it.

Video recorders each including a large-capacity recording medium such as a large-capacity hard disk can record many television programs. There are television receivers equipped with such large-capacity video recorders. As the number of television programs recorded in a video recorder increases, it is more difficult for a user to comprehensively grasp what television programs are recorded. When recorded television programs are so many, the user has some trouble in finding favorite one.

Some television stations multiplex auxiliary program information with main television signals in order to help users of television receivers to select desired ones from many broadcast programs represented by the main television signals. The auxiliary program information represents the title, the on-air time, the on-air channel, the genre, the outline, and the performer list of each broadcast program.

There are television receivers employing the auxiliary program information to form electronic program guides. The displays of the television receivers indicate the electronic program guides to help users' choices of broadcast programs.

Some television receivers equipped with video recorders simultaneously record broadcast programs and related auxiliary program information. The recorded auxiliary program information is indicated on the television display to help a television user to choose one among the recorded broadcast programs as an object to be played back.

An advanced television receiver equipped with a video recorder automatically generates a signal representing a history about the recording of broadcast programs. The history signal includes auxiliary program information related to the recorded broadcast programs. The history signal is stored in a memory within the television receiver, and is updated from time to time. In the television receiver, keywords are extracted from the auxiliary program information in the history signal, and an analysis is given thereof to decide what keywords a television user is interested in. The recorded broadcast programs are sorted according to the keywords of interest to the user. The sort result is presented to the user to help user's decision as to which of the recorded programs should be selected as an object to be played back.

Japanese patent application publication number 2002-7460 discloses a television receiver which receives meta-information in addition to broadcast contents. The television receiver can store the received broadcast contents. The meta-information includes keywords for each of the broadcast contents. The television receiver extracts keywords from the meta-information for each broadcast content referred to by a television user. The extracted key words are weighted according to appearance frequency. Extracted keywords appearing at high frequencies are considered to be ones of interest to the user. On the other hand, extracted keywords appearing at low frequencies are considered to be ones of no interest to the user. For all broadcast contents referred to by the user, an interest system tree is generated on the basis of extracted keywords of interest to the user and the result of weighting the extracted keywords. In the interest system tree, the keywords correspond to nodes respectively.

The television receiver in Japanese application 2002-7460 generates a content selection picture indicated on a display. The content selection picture is based on the interest system tree. In more detail, the content selection picture is of a directory structure which agrees with the structure of the interest system tree. Regarding the content selection picture, there are directories corresponding to the nodes in the interest system tree respectively. Thus, the directories regarding the content selection picture correspond to the keywords, respectively. Specifically, the names of the directories use the corresponding keywords, respectively. From the directories, ones are selected which are most related to the broadcast contents respectively. Pointers for referring to the broadcast contents are placed in the selected directories, respectively. The user can choose one among the broadcast contents by using the content selection picture and tracing a path through directories.

Generally, keywords appearing at high frequencies are not always ones of interest to the user. In some cases, keywords appearing at high frequencies are ones of no interest to the user while keywords appearing at low frequencies are ones of interest.

In the television receiver of Japanese application 2002-7460, keywords appearing at high frequencies are always placed in the interest system tree even when they are of no interest to the user. Therefore, the interest system tree and also the content selection picture tend to be unreliable.

### SUMMARY OF THE INVENTION

It is a first object of this invention to provide a reliable apparatus for facilitating the selection of television programs.

It is a second object of this invention to provide a reliable method of facilitating the selection of television programs.

It is a third object of this invention to provide a reliable computer program for facilitating the selection of television programs.

A first aspect of this invention provides a program-selection facilitating apparatus comprising means for presenting ones among broadcast programs as selection-candidate programs to a user; means for selecting one from the selection-candidate programs in accordance with a command from the user; means for generating a program-selection history in response to the selection of one from the selection-candidate programs; means for storing the program-selection history; means for obtaining program information pieces corresponding to the broadcast programs respectively; means for storing the obtained program information pieces; means for extracting keywords from the stored program information pieces; means for calculating degrees of user's preference for the extracted keywords respectively in response to the stored program-selection history; means for comparing the calculated preference degrees of the extracted keywords, for arranging the extracted keywords in an order of calculated preference degree, and for selecting, among the arranged keywords, a prescribed number of successive keywords starting from one having a highest calculated preference degree as preferred keywords; means for presenting the preferred keywords to the user; means for choosing one among the preferred keywords in accordance with a command from the user; means for extracting ones from the stored program information pieces, the extracted program information pieces containing the preferred keywords; means for assigning the preferred keywords the broadcast programs corresponding to the extracted program information pieces; means for detecting the broadcast programs which are assigned to the chosen preferred keyword as selection-candidate programs; means for presenting, to the user, at least portions of the program information pieces corresponding to the selection-candidate programs; means for generating a keyword-operation history in response to the choice of one among the preferred keywords; means for storing the generated keyword-operation history; means for calculating degrees of user's interest in the extracted keywords respectively from the stored keyword-operation history; means for updating the calculated preference degrees of the extracted keywords to generate new calculated preference degrees of the extracted keywords in response to the calculated interest degrees of the extracted keywords; means for comparing the new calculated preference degrees of the extracted keywords, for arranging the extracted keywords in an order of new calculated preference degree, and for selecting, among the arranged keywords, a prescribed number of successive keywords starting from one having a highest new calculated preference degree as new preferred keywords; means for presenting the new preferred keywords to the user; and means for choosing one among the new preferred keywords in accordance with a command from the user.

A second aspect of this invention provides a program-selection facilitating method comprising the steps of presenting ones among broadcast programs as selection-candidate programs to a user; selecting one from the selection-candidate programs in accordance with a command from the user; generating a program-selection history in response to the selection of one from the selection-candidate programs; storing the program-selection history; obtaining program information pieces corresponding to the broadcast programs respectively; storing the obtained program information pieces; extracting keywords from the stored program information pieces; calculating degrees of user's preference for the extracted keywords respectively in response to the stored program-selection history; comparing the calculated preference degrees of the extracted keywords, arranging the extracted keywords in an order of calculated preference degree, and selecting, among the arranged keywords, a prescribed number of successive keywords starting from one having a highest calculated preference degree as preferred keywords; presenting the preferred keywords to the user; choosing one among the preferred keywords in accordance with a command from the user; extracting ones from the stored program information pieces, the extracted program information pieces containing the preferred keywords; assigning the preferred keywords the broadcast programs corresponding to the extracted program information pieces; detecting the broadcast programs which are assigned to the chosen preferred keyword as selection-candidate programs; presenting, to the user, at least portions of the program information pieces corresponding to the selection-candidate programs; generating a keyword-operation history in response to the choice of one among the preferred keywords; storing the generated keyword-operation history; calculating degrees of user's interest in the extracted keywords respectively from the stored keyword-operation history; updating the calculated preference degrees of the extracted keywords to generate new calculated preference degrees of the extracted keywords in response to the calculated interest degrees of the extracted keywords; comparing the new calculated preference degrees of the extracted keywords, arranging the extracted keywords in an order of new calculated preference degree, and selecting, among the arranged keywords, a prescribed number of successive keywords starting from one having a highest new calculated preference degree as new preferred keywords; presenting the new preferred keywords to the user; and choosing one among the new preferred keywords in accordance with a command from the user.

A third aspect of this invention provides a computer program for facilitating the selection of broadcast programs by a user. The computer program comprises the steps of presenting ones among broadcast programs as selection-candidate programs to a user; selecting one from the selection-candidate programs in accordance with a command from the user; generating a program-selection history in response to the selection of one from the selection-candidate programs; storing the program-selection history; obtaining program information pieces corresponding to the broadcast programs respectively; storing the obtained program information pieces; extracting keywords from the stored program information pieces; calculating degrees of user's preference for the extracted keywords respectively in response to the stored program-selection history; comparing the calculated preference degrees of the extracted keywords, arranging the extracted keywords in an order of calculated preference degree, and selecting, among the arranged keywords, a prescribed number of successive keywords starting from one having a highest calculated preference degree as preferred keywords; presenting the preferred keywords to the user; choosing one among the preferred keywords in accordance with a command from the user; extracting ones from the stored program information pieces, the extracted program information pieces containing the preferred keywords; assigning the preferred keywords the broadcast programs corresponding to the extracted program information pieces; detecting the broadcast programs which are assigned to the chosen preferred keyword as selection-candidate programs; presenting, to the user, at least portions of the program information pieces corresponding to the selection-candidate programs; generating a keyword-operation history in response to the choice of one among the preferred keywords; storing the generated keyword-operation history; calculating degrees of user's interest in the extracted keywords respectively from the stored keyword-operation history; updating the calculated preference degrees of the extracted keywords to generate new calculated preference degrees of the extracted keywords in response to the calculated interest degrees of the extracted keywords; comparing the new calculated preference degrees of the extracted keywords, arranging the extracted keywords in an order of new calculated preference degree, and selecting, among the arranged keywords, a prescribed number of successive keywords starting from one having a highest new calculated preference degree as new preferred keywords; presenting the new preferred keywords to the user; and choosing one among the new preferred keywords in accordance with a command from the user.

This invention has the following advantages. Keywords having high user's preference degrees are detected in response to a stored program-selection history and stored program information pieces corresponding to broadcast programs. The detected keywords are presented to a user as preferred keywords. A keyword-operation history reflects user's choice of one among the preferred keywords which is carried out to select one from the broadcast programs. The key-operation history is stored. The stored key-operation history is used in calculating the degrees of user's preference for keywords. Thereby, the preferred keywords presented to the user can be better accorded with the user's preference. Thus, the user can easily and correctly select a broadcast program of high interest to the user from the broadcast programs.

### BRIEF DESCRIPTION OF THE DRAWINGS

FIG. 1 is a diagram of a program-selection facilitating apparatus in an embodiment of this invention.

FIG. 2 is a block diagram of a modified program-selection facilitating apparatus in the embodiment of this invention.

FIG. 3 is a flowchart of a segment of a computer program for a computer system in FIG. 2.

FIG. 4 is a flowchart of a computer program for a preference analyzer in FIG. 1.

FIG. 5 is a diagram showing an example of a keyword-choice picture.

FIG. 6 is a diagram showing an example of a program-selection picture.

### DETAILED DESCRIPTION OF THE INVENTION

A television broadcast system includes television stations and television receivers. The television stations broadcast television signals representative of broadcast programs (television programs) while the television receivers catch the broadcasted television signals. The television stations multiplex program information pieces (auxiliary program information pieces) with main television signals representative of the broadcast programs to form program-information-added television signals. The television stations broadcast the program-information-added television signals. The program information pieces correspond to the broadcast programs, respectively. Each program information piece contains text data which represents items concerning the corresponding broadcast program, for example, the title (the name), the on-air time, the on-air channel, the genre, the outline (the brief explanation), and the performer list of the corresponding broadcast program. Thus, each program information piece contains keywords for the corresponding broadcast program. Each program information piece further contains the ID (the identification codeword or identifier) of the corresponding broadcast program. Each program information piece corresponds to a currently-broadcasted program, a program scheduled to be broadcasted in the future, or a program broadcasted in the past.

In general, the program information pieces constitute information representing, for example, an EPG (electronic program guide) which is an on-screen guide to the broadcast programs. The EPG allows a viewer to navigate, select, and discover content by time, title, channel, genre, etc.

Each television receiver separates the received television signals into the main television signals and the program information pieces. The television receiver indicates the program information pieces on its display. The indicated program information pieces help a user of the television receiver to select desired ones from the broadcast programs represented by the main television signals.

It should be noted that each television receiver may receive the program information pieces from a program guide server through a communication network such as the Internet.

A program-selection facilitating apparatus in an embodiment of this invention is provided in a television receiver including a video recorder. The apparatus makes a history about the selection of broadcast programs by a user of the television receiver. The apparatus extracts keywords from program information pieces corresponding to broadcast programs received by the television receiver. The apparatus determines the degrees of user's preference (user's taste) for the respective extracted keywords on the basis of the program-selection history. The extracted keywords are arranged in the order of preference degree. A prescribed number of successive keywords starting from one with the highest user's preference degree are selected from the arranged keywords. The apparatus indicates the selected keywords on a display. When one is chosen among the indicated keywords by the user, the apparatus makes a list of names of broadcast programs corresponding to program information pieces each containing the chosen keyword. The apparatus indicates the list on the display. Then, by referring to the indicated list, the user can select one from the broadcast programs having the names in the indicated list. Subsequently, the user can view the selected broadcast program. The apparatus utilizes information about the user's choice of the keyword in next and later determinations of the degrees of user's preference for respective extracted keywords. As a result, the determined user's preference degrees are more accurate.

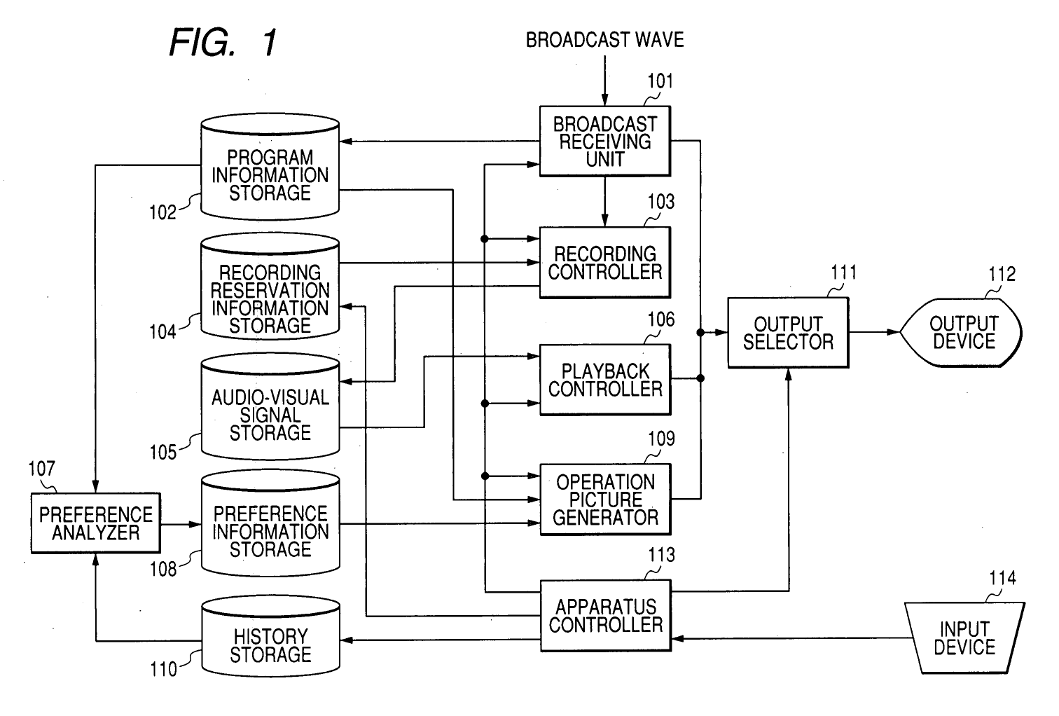

FIG. 1 shows the program-selection facilitating apparatus in the embodiment of this invention. The apparatus of FIG. 1 includes a broadcast receiving unit 101 and an apparatus controller 113.

The broadcast receiving unit 101 has a tuner and a demodulator/separator. When the apparatus controller 113 notifies the broadcast receiving unit 101 of a desired channel, the broadcast receiving unit 101 tunes to an RF television signal of the desired channel which is broadcasted from a television station. Thus, the broadcast receiving unit 101 receives the RF television signal of the desired channel. The broadcast receiving unit 101 demodulates the received RF television signal into a baseband television signal, and separates the baseband television signal into an audio-visual signal (a main television signal) and a program information piece. The audio-visual signal represents a broadcast program (a television program). The broadcast receiving unit 101 outputs the audio-visual signal to a recording controller 103 and an output selector 111. The broadcast receiving unit 101 outputs the program information piece to a storage device 102.

The program-information storage device 102 includes, for example, a combination of a hard disk and a drive for the hard disk. The program-information storage device 102 stores each program information piece outputted from the broadcast receiving unit 101. Usually, there are a plurality of program information pieces in the program-information storage device 102. A preference analyzer 107 and an operation picture generator 109 can read out the program information pieces from the program-information storage device 102. A set of the program information pieces in the program-information storage device 102 is updated from time to time.

The recording controller 103 reads out recording reservation information from a storage device 104. The recording reservation information indicates an appointed recording-start time and an appointed recording-end time. The recording controller 103 decides whether or not the present time reaches the appointed recording-start time indicated by the read-out recording reservation information. When the apparatus controller 113 feeds the recording controller 103 with an instruction to start recording or when the present time reaches the appointed recording-start time, the recording controller 103 passes the audio-visual signal to a storage device 105 for audio-visual signals. In addition, the recording controller 103 decides whether or not the present time reaches the appointed recording-end time indicated by the read-out recording reservation information. When the apparatus controller 113 feeds the recording controller 103 with an instruction to stop recording or when the present time reaches the appointed recording-end time, the recording controller 103 blocks the transmission of the audio-visual signal from the broadcast receiving unit 101 to the audio-visual-signal storage device 105.

The recording-reservation-information storage device 104 includes, for example, a combination of a hard disk and a drive for the hard disk. The recording-reservation-information storage device 104 stores the recording reservation information fed from the apparatus controller 113. The recording reservation information contains information about a television channel corresponding to an audio-visual signal, the recording of which is booked.

The audio-visual-signal storage device 105 includes, for example, a combination of a hard disk and a drive for the hard disk. The audio-visual-signal storage device 105 stores the audio-visual signal fed from the recording controller 103. A playback controller 106 can read out an audio-visual signal from the audio-visual-signal storage device 105. A lot of audio-visual signals of different broadcast programs can be stored in the audio-visual-signal storage device 105.

When the apparatus controller 113 feeds the playback controller 106 with an instruction to start playing back a designated program, the playback controller 106 reads out an audio-visual signal of the designated program from the audio-visual-signal storage device 105. The playback controller 106 feeds the read-out audio-visual signal to the output selector 111. When the apparatus controller 113 feeds the playback controller 106 with an instruction to stop playing back the designated program, the playback controller 106 stops reading out the audio-visual signal of the designated program from the audio-visual-signal storage device 105. In addition, the playback controller 106 stops feeding the read-out audio-visual signal to the output selector 111.

The preference analyzer 107 reads out the program information pieces from the program-information storage device 102. The preference analyzer 107 reads out information of a program-selection history and information of a keyword-operation history from a storage device 110. The preference analyzer 107 generates preference information on the basis of the read-out program information pieces, the read-out program-selection history information, and the read-out keyword-operation history information. The preference analyzer 107 writes the generated preference information into a storage device 108. Specifically, the preference analyzer 107 is triggered when the present time reaches an appointed time or when a program information piece is received. When triggered, the preference analyzer 107 reads out the information of the program-selection history and the information of the keyword-operation history from the storage device 110. Then, the preference analyzer 107 reads out program information pieces related to the program-selection history from the program-information storage device 102. The preference analyzer 107 analyzes the read-out program information pieces, the read-out program-selection history information, and the read-out keyword-operation history information to generate information about user's preference. The preference analyzer 107 writes the generated preference information into the storage device 108. In more detail, the preference analyzer 107 extracts keywords from the read-out program information pieces. The preference analyzer 107 determines the degrees of user's preference (user's taste) for the respective extracted keywords on the basis of the program-selection history and the keyword-operation history. The preference analyzer 107 arranges the extracted keywords in the order of preference degree. Among the arranged keywords, the preference analyzer 107 selects a prescribed number of successive keywords starting from one with the highest user's preference degree. The selected keywords are regarded as ones of interest to the user, and are called the preferred keywords. The preference analyzer 107 makes a list of the preferred keywords (the selected keywords). The preference analyzer 107 generates a first information piece indicating the preferred keyword list. For each of the extracted keywords, the preference analyzer 107 makes a list of the IDs (the identification codewords or the identifiers) of broadcast programs corresponding to program information pieces each containing the present extracted keyword. The preference analyzer 107 generates a second information piece indicating the program ID lists. The preference analyzer 107 combines the first information piece and the second information piece into preference information before writing the preference information into the storage device 108.

The preference-information storage device 108 includes, for example, a combination of a hard disk and a drive for the hard disk. The preference-information storage device 108 stores the preference information fed from the preference analyzer 107. The operation picture generator 109 can read out the preference information from the preference-information storage device 108.

The operation picture generator 109 reads out the program information pieces from the program-information storage device 102. The operation picture generator 109 reads out the preference information from the preference-information storage device 108. The operation picture generator 109 generates information of a recording-reservation picture, information of a keyword-choice picture, and information of a program-selection picture on the basis of the read-out program information pieces and the read-out preference information. The operation picture generator 109 feeds the recording-reservation picture information, the keyword-choice picture information, and the program-selection picture information to the output selector 111. When the apparatus controller 113 feeds the operation picture generator 109 with an instruction to make a recording-reservation picture, the operation picture generator 109 reads out the program information pieces from the program-information storage device 102. Then, the operation picture generator 109 makes a recording-reservation picture on the basis of the read-out program information pieces. The operation picture generator 109 feeds information of the recording-reservation picture to the output selector 111. When the apparatus controller 113 feeds the operation picture generator 109 with an instruction to make a keyword-choice picture, the operation picture generator 109 reads out the piece of the preference information which represents the preferred keyword list from the preference-information storage device 108. The operation picture generator 109 makes a keyword-choice picture on the basis of the preferred keyword list. The operation picture generator 109 feeds information of the keyword-choice picture to the output selector 111. When the apparatus controller 113 feeds the operation picture generator 109 with an instruction to make a program-selection picture and notifies the operation picture generator 109 of a designated keyword (a chosen keyword), the operation picture generator 109 reads out the piece of the preference information from the preference-information storage device 108 which represents the list of the IDs of broadcast programs corresponding to program information pieces each containing the designated keyword. In addition, the operation picture generator 109 reads out program information pieces, which correspond to the program IDs in the list, from the program-information storage device 102. The operation picture generator 109 makes a program-selection picture on the basis of the read-out program ID list and the read-out program information pieces. The operation picture generator 109 feeds information of the program-selection picture to the output selector 111.

The history storage device 110 includes, for example, a combination of a hard disk and a drive for the hard disk. The history storage device 110 stores the information of the program-selection history and the information of the keyword-operation history which are fed from the apparatus controller 113. The preference analyzer 107 can read out the information of the program-selection history and the information of the keyword-operation history from the history storage device 110.

The information of the program-selection history includes (1) information representative of the time at which each of broadcast programs is selected, and (2) information representative of the IDs of the selected broadcast programs.

The information of the keyword-operation history includes (1) information representative of each keyword chosen by the user from the keyword list in each keyword-choice picture, (2) information representative of the time at which the keyword is chosen, (3) information representative of all other keywords (all non-chosen keywords) listed in the keyword-choice picture, (4) information representative of each keyword subjected to deleting operation by the user and listed in each keyword-choice picture, and (5) information representative of each keyword subjected to settling operation by the user and listed in each keyword-choice picture.

The keyword deleting operation removes a designated keyword from a keyword-choice picture. In other words, the keyword deleting operation causes the designated keyword to be out of the keyword-choice picture. The keyword settling operation enables a designated keyword to be continuously in a keyword-choice picture.

The output selector 111 selects at least one among the audio-visual signal fed from the broadcast receiving unit 101, the audio-visual signal fed from the playback controller 106, and the picture information fed from the operation picture generator 109 in response to an instruction from the apparatus controller 113. The output selector 111 passes the selected audio-visual signal or the selected picture information to an output device 112.

The output device 112 includes an image generator and a sound generator. The image generator is, for example, a CRT or a liquid crystal display. The sound generator is, for example, a loudspeaker. The output device 112 indicates images represented by the audio-visual signal or the picture information fed from the output selector 111. At the same time, the output device 112 can generate sounds represented by the audio-visual signal.

An input device 114 has, for example, a combination of a remote control transmitter and a remote control receiver. The user can input various instructions by operating the input device 114. The various instructions include an instruction to select a channel to be viewed (an instruction to designate a desired channel), an instruction to start the recording of a currently-viewed broadcast program, an instruction to stop the recording thereof, an instruction to indicate a recording-reservation picture, an instruction to make a recording reservation, an instruction to play back a recorded broadcast program, an instruction to stop the playback thereof, an instruction to indicate a keyword-choice picture, an instruction to indicate a program-selection picture, an instruction to delete a keyword from a keyword-choice picture, an instruction to settle a keyword in a keyword-choice picture, and an instruction to choose a keyword in a keyword-choice picture. The inputted instructions are sent from the input device 114 to the apparatus controller 113.

When an instruction to designate a desired channel is sent to the apparatus controller 113 from the input device 114, the apparatus controller 113 orders the broadcast receiving unit 101 to receive an RF television signal of the desired channel. An audio-visual signal corresponding to the desired channel is sent from the broadcast receiving unit 101 to the recording controller 103 and the output selector 111. The apparatus controller 113 orders the output selector 111 to pass the audio-visual signal from the broadcast receiving unit 101 to the output device 112. The output device 112 displays images represented by the audio-visual signal while generating sounds represented by the audio-visual signal.

When an instruction to start the recording of a currently-viewed broadcast program is sent to the apparatus controller 113 from the input device 114, the apparatus controller 113 orders the recording controller 103 to start the recording of a corresponding audio-visual signal into the audio-visual-signal storage device 105. When an instruction to stop the recording of a currently-viewed broadcast program is sent to the apparatus controller 113 from the input device 114, the apparatus controller 113 orders the recording controller 103 to stop the recording of a corresponding audio-visual signal into the audio-visual-signal storage device 105.

When an instruction to indicate a recording-reservation picture is sent to the apparatus controller 113 from the input device 114, the apparatus controller 113 orders the operation picture generator 109 to generate information of a recording-reservation picture and to feed the generated picture information to the output selector 111. In addition, the apparatus controller 113 orders the output selector 111 to pass the picture information from the operation picture generator 109 to the output device 112. As a result, the output device 112 displays the recording-reservation picture.

The user can select a broadcast program as an object with respect to a recording reservation by operating the input device 114 while referring to the recording-reservation picture displayed by the output device 112. Then, the user can input an instruction to make a recording reservation for the selected broadcast program by operating the input device 114. An instruction to make a recording reservation which is inputted via the input device 114 contains recording reservation information representing the appointed time of starting the reserved recording, the appointed time of stopping the reserved recording, and a channel corresponding to the recording-reserved program for the recording reservation.

When the user's selection of a broadcast program as an object with respect to a recording reservation is notified to the apparatus controller 113 from the input device 114 and a subsequent instruction to make a recording reservation for the selected broadcast program is sent to the apparatus controller 113 from the input device 114, the apparatus controller 113 extracts recording reservation information from the received instruction and outputs the extracted recording reservation information to the recording-reservation-information storage device 104.

When an instruction to play back a recorded broadcast program is sent to the apparatus controller 113 from the input device 114, the apparatus controller 113 orders the playback controller 106 to read out an audio-visual signal of the designated broadcast program from the audio-visual-signal storage device 105 and to feed the read-out audio-visual signal to the output selector 111. In addition, the apparatus controller 113 orders the output selector 111 to pass the audio-visual signal from the playback controller 106 to the output device 112. As a result, the output device 112 displays images represented by the audio-visual signal while generating sounds represented by the audio-visual signal. When an instruction to stop the playback of the recorded broadcast program is sent to the apparatus controller 113 from the input device 114, the apparatus controller 113 orders the playback controller 106 to stop reading out the audio-visual signal of the designated broadcast program from the audio-visual-signal storage device 105.

When an instruction to indicate a keyword-choice picture is sent to the apparatus controller 113 from the input device 114, the apparatus controller 113 orders the operation picture generator 109 to generate information of a keyword-choice picture and to feed the generated picture information to the output selector 111. In addition, the apparatus controller 113 orders the output selector 111 to pass the picture information from the operation picture generator 109 to the output device 112. As a result, the output device 112 indicates the keyword-choice picture.

The user can choose a keyword by operating the input device 114 while referring to the keyword-choice picture displayed by the output device 112. Then, the user can input an instruction to indicate a program-selection picture by operating the input device 114.

When the user's choice of a keyword is notified to the apparatus controller 113 from the input device 114 and a subsequent instruction to indicate a program-selection picture is sent to the apparatus controller 113 from the input device 114, the apparatus controller 113 orders the operation picture generator 109 to generate information of a program-selection picture about broadcast programs corresponding to program information pieces each containing the chosen keyword. In addition, the apparatus controller 113 orders the operation picture generator 109 to feed the generated picture information to the output selector 111. Furthermore, the apparatus controller 113 orders the output selector 111 to pass the picture information from the operation picture generator 109 to the output device 112. As a result, the output device 112 displays the program-selection picture.

The user can input an instruction to delete a keyword by operating the input device 114 while referring to the keyword-choice picture displayed by the output device 112.

When an instruction to delete a keyword is sent to the apparatus controller 113 from the input device 114, the apparatus controller 113 generates information of a keyword-operation history concerning the present keyword deletion. The apparatus controller 113 feeds the information of the keyword-operation history to the history storage device 110. The apparatus controller 113 may update information of a keyword-operation history in the history storage device 110 in response to the present keyword deletion.

The user can input an instruction to settle a keyword by operating the input device 114 while referring to the keyword-choice picture displayed by the output device 112.

When an instruction to settle a keyword is sent to the apparatus controller 113 from the input device 114, the apparatus controller 113 generates information of a keyword-operation history concerning the present keyword settlement. The apparatus controller 113 feeds the information of the keyword-operation history to the history storage device 110. The apparatus controller 113 may update information of a keyword-operation history in the history storage device 110 in response to the present keyword settlement.

The apparatus controller 113 generates information of a program-selection history in accordance with user's selections of broadcast programs which are caused by an instruction to select a channel to be viewed (an instruction to designate a desired channel), an instruction to start the recording of a currently-viewed broadcast program, an instruction to make a recording reservation, and an instruction to play back a recorded broadcast program. These instructions are inputted via the input device 114. The apparatus controller 113 feeds the information of the program-selection history to the history storage device 110. The apparatus controller 113 may update information of a program-selection history in the history storage device 110 in response to every new user's selection of a broadcast program.

The user can input an instruction to choose a keyword by operating the input device 114 while referring to the keyword-choice picture displayed by the output device 112.

When an instruction to choose a keyword is sent to the apparatus controller 113 from the input device 114, the apparatus controller 113 generates information of a keyword-operation history concerning the present keyword choice. The apparatus controller 113 feeds the information of the keyword-operation history to the history storage device 110. The apparatus controller 113 may update information of a keyword-operation history in the history storage device 110 in response to the present keyword choice.

It should be noted that a common storage device having a combination of a hard disk and a drive for the hard disk may be shared by the program-information storage device 102, the recording-reservation-information storage device 104, the audio-visual-signal storage device 105, the preference-information storage device 108, and the history storage device 110.

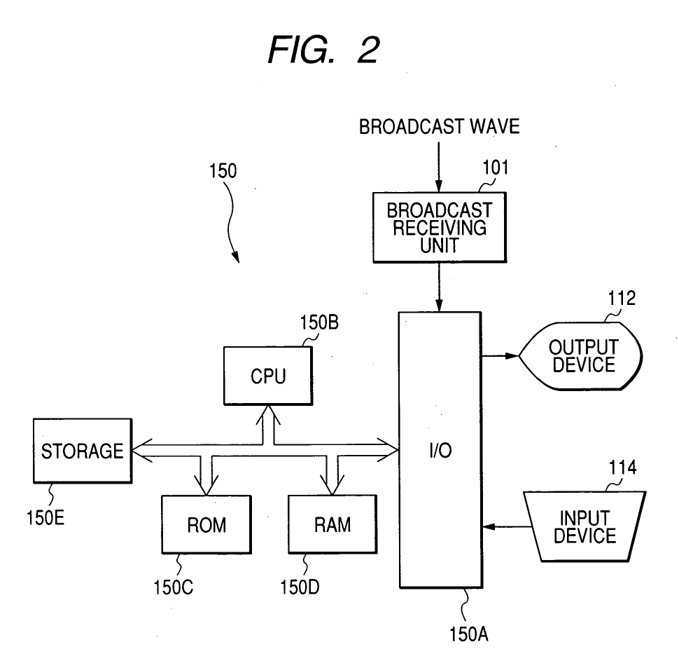

The program-selection facilitating apparatus may be modified to utilize a computer system. FIG. 2 shows the modified apparatus. The apparatus in FIG. 2 includes a computer system 150 connected to the broadcast receiving unit 101, the output device 112, and the input device 114. The computer system 150 has a combination of an input/output port (an interface) 150A, a CPU 150B, a ROM 150C, a RAM 150D, and a storage device 150E. The input/output port 150A is connected to the broadcast receiving unit 101, the output device 112, and the input device 114. The computer system 150 operates in accordance with a computer program stored in the ROM 150C, the RAM 150D, or the storage device 150E. The storage device 150E includes, for example, a combination of a hard disk and a drive for the hard disk. The storage device 150E corresponds to the program-information storage device 102, the recording-reservation-information storage device 104, the audio-visual-signal storage device 105, the preference-information storage device 108, and the history storage device 110 in FIG. 1.

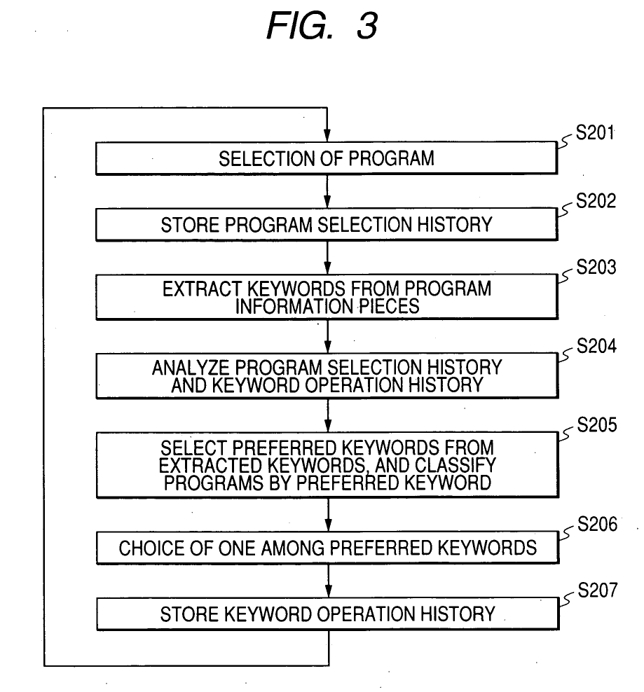

FIG. 3 is a flowchart of a segment of the computer program for the computer system 150E in the apparatus of FIG. 2. As shown in FIG. 3, a first step S201 of the computer program segment monitors the input device 114 and waits until the user selects a broadcast program by operating the input device 114. The selection of a broadcast program is caused by an instruction to select a channel to be viewed (an instruction to designate a desired channel), an instruction to start the recording of a currently-viewed broadcast program, an instruction to make a recording reservation, or an instruction to play back a recorded broadcast program which is inputted via the input device 114. When the user selects a broadcast program, the computer program advances from the step S201 to a step S202.

The step S202 reads out, from the storage device 150E, the program information piece corresponding to the selected broadcast program. The step S202 obtains the identifier (the ID or the identification codeword) of the selected broadcast program from the read-out program information piece. The step S202 also obtains information representative of the time at which the broadcast program is selected. The step S202 stores the obtained program identifier and the obtained program-selection-time information in the storage device 150E as pieces of information of a program-selection history. Thus, the step S202 updates the information of the program-selection history in the storage device 150E in accordance with the obtained program identifier and the obtained program-selection-time information.

A step S203 following the step S202 reads out all program information pieces from the storage device 150E. The step S203 subjects the letters and characters represented by text data in the read-out program information pieces to a morphological analysis to extract keywords. The letters and characters express items concerning each related broadcast program, for example, the title and the outline (the brief explanation) of each related broadcast program. In the case where each program information piece includes attribute information such as information representative of the genre of the corresponding broadcast program, information representative of the performer list for the corresponding broadcast program, and information representative of keywords for the corresponding broadcast program, the genre and performer names and the keywords related to the attribute information may be used as extracted keywords. The step S203 may carry out the extraction of keywords once a day when a set of stored program information pieces is updated. In this case, the step S203 saves information of the extracted keywords in the storage device 150E.

The step S203 recognizes the relation between the extracted keywords and the broadcast programs (the assignment of the broadcast programs to the extracted keywords) by referring to the program IDs in the program information pieces. In general, one extracted keyword relates to one or more broadcast programs while one broadcast program relates to one or more extracted keywords.

A step S204 subsequent to the step S203 retrieves the information of the program-selection history and information of a keyword-operation history from the storage device 150E. The step S204 analyzes the program-selection history and the keyword-operation history to calculate the degrees of user's preference for the keywords extracted by the step S203. At the first execution of the step S204, information of a keyword-operation history is absent, and only the program-selection history is analyzed.

A step S205 following the step S204 compares the calculated degrees of user's preference for the extracted keywords with each other. The step S205 arranges the extracted keywords in the order of calculated preference degree. Among the arranged keywords, the step S205 selects a prescribed number of successive keywords starting from one with the highest preference degree. The selected keywords are called the preferred keywords. The step S205 controls the output device 112 to display and present the preferred keywords to the user. The step S205 refers to the relation between the extracted keywords and the broadcast programs (the assignment of the broadcast programs to the extracted keywords), and thereby classifies the broadcast programs according to keyword in a manner such that broadcast programs corresponding to program information pieces containing the preferred keywords are assigned to the preferred keywords. Thus, the step S205 classifies the broadcast programs according to preferred keyword.

A step S206 subsequent to the step S205 monitors the input device 114 and waits until the user chooses one among the preferred keywords displayed on the output device 112 by operating the input device 114. When the user chooses one among the preferred keywords, the step S206 detects broadcast programs assigned to the chosen keyword by referring to the result of the broadcast-program classification by the step S205 or the relation between the extracted keywords and the broadcast programs. The step S206 feeds the output device 112 with portions of program information pieces corresponding to the detected broadcast programs, and controls the output device 112 to indicate the names (the titles) of the detected broadcast programs. Normally, the user selects one from the broadcast programs, whose name or names are indicated on the output device 112, by operating the input device 114. The user's selection of the broadcast program will be sensed at the next execution of the step S201.

A step S207 following the step S206 stores information about the user's choice of the keyword at the step S206 into the storage device 150E as information of a keyword-operation history. The step S207 may update information of a keyword-operation history in the storage device 150E in accordance with the information about the user's choice of the keyword at the step S206. After the step S207, the computer program returns to the step S202.

Preferably, the preference analyzer 107 in FIG. 1 includes a computer-based device or a similar programmable device having a combination of an input/output port (an interface), a processing section, a ROM, and a RAM. In this case, the preference analyzer 107 operates in accordance with a computer program stored in the ROM.

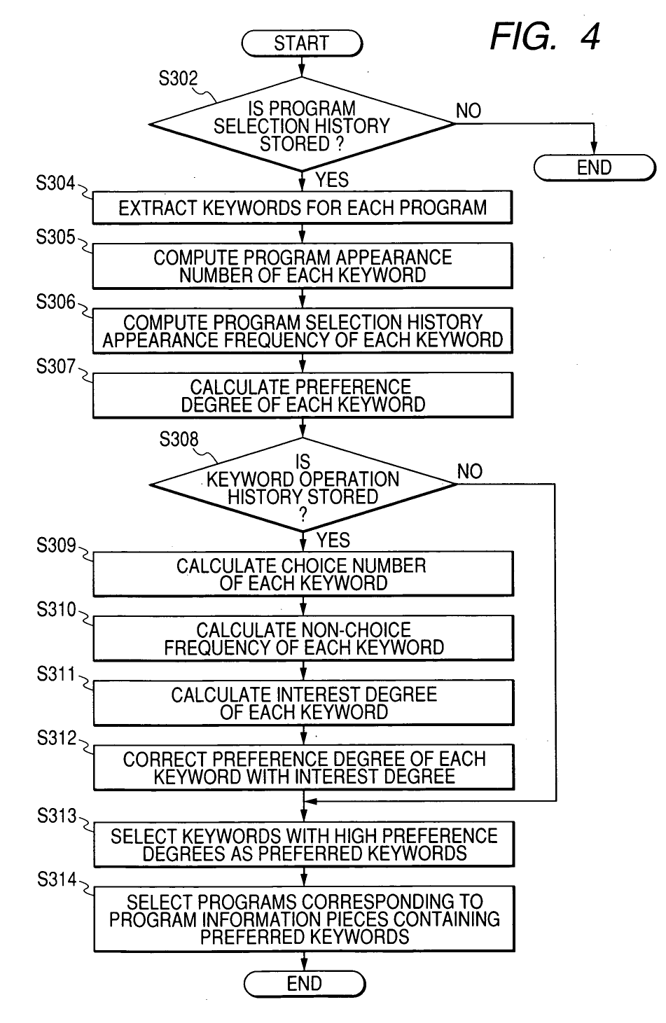

FIG. 4 is a flowchart of the computer program for the preference analyzer 107. The computer program in FIG. 4 is iteratively executed. The computer program in FIG. 4 may be a segment of the computer program for the computer system 150E in the apparatus of FIG. 2.

As shown in FIG. 4, a first step S302 of the computer program decides whether or not information of a program-selection history is present in the history storage device 110 (the storage device 150E). When information of a program-selection history is present, the computer program advances from the step S302 to a step S304. Otherwise, the computer program exits from the step S302, and then the current execution cycle of the computer program ends.

The step S304 reads out all program information pieces from the program-information storage device 102 (the storage device 150E). The step S304 subjects the letters and characters represented by text data in the read-out program information pieces to a morphological analysis to extract keywords formed by meaningful words such as nouns. The letters and characters express items concerning each related broadcast program, for example, the title and the outline (the brief explanation) of each related broadcast program. In the case where each program information piece includes attribute information such as information representative of the genre of the corresponding broadcast program, information representative of the performer list for the corresponding broadcast program, and information representative of keywords for the corresponding broadcast program, the genre and performer names and the keywords related to the attribute information may be used as extracted keywords. The step S304 carries out the extraction of keywords for broadcast programs corresponding to all the program information pieces in the program-information storage device 102 (the storage device 150E). The number of the broadcast programs corresponding to all the program information pieces in the program-information storage device 102 is denoted by N. The step S304 may carry out the extraction of keywords once a day when a set of the program information pieces in the program-information storage device 102 is updated. In this case, the step S304 saves information of the extracted keywords in the program-information storage device 102 (the storage device 150E) or another storage device.

The step S304 recognizes the relation between the extracted keywords and the broadcast programs (the assignment of the broadcast programs to the extracted keywords) by referring to the program IDs in the program information pieces. In general, one extracted keyword relates to one or more broadcast programs while one broadcast program relates to one or more extracted keywords.

A step S305 following the step S304 calculates the number of times each of the extracted keywords appears, that is, the frequency at which each of the extracted keywords appears in connection with the broadcast programs. Specifically, the appearance frequency of each of the extracted keywords is equal to the number of broadcast programs corresponding to program information pieces each containing the present extracted keyword. The appearance frequency of each of the extracted keywords is called the keyword appearance program number. In more detail, the extracted keywords are sequentially designated as calculation-object keywords “k” where k=1, 2, 3, . . . , k0. The value “k0” is equal to the number of the extracted keywords. For each calculation-object keyword “k”, the step S305 counts the number of broadcast programs corresponding to program information pieces each containing the calculation-object keyword “k”. For each calculation-object keyword “k”, the step S305 sets the counted number as a keyword appearance program number Nk. Even in the case where a calculation-object keyword “k” appears a plurality of times in a program information piece corresponding to one broadcast program, a keyword appearance program number is equal to “1” for the broadcast program.

A step S306 subsequent to the step S305 calculates a program-selection history appearance frequency Fk,h of each calculation-object keyword “k”. Specifically, the step S306 refers to the information of the program-selection history in the history storage device 110 (the storage device 150E). The step S306 detects all broadcast programs contained or mentioned in the program-selection history. The detected broadcast programs are sequentially designated as calculation-object broadcast programs “h” where h=1, 2, 3, . . . , h0. The value h0 is equal to the number of the detected broadcast programs. The step S306 detects keywords extracted from a program information piece corresponding to each calculation-object broadcast program “h”. The step S306 counts the number Nk,h of times each calculation-object keyword “k” appears in the detected keywords or appears as one of the detected keywords. The step S306 computes the program-selection history appearance frequency Fk,h of each calculation-object keyword “k” from the counted number Nk,h according to an equation given as:

$${F}_{k , n} = \frac{{log}_{2} ( {N}_{k , h} + 1 )}{{log}_{2} ( Nh )} \qquad ( 1 )$$

where Nh denotes the number of the detected keywords, that is, the number of the keywords extracted from a program information piece corresponding to each calculation-object broadcast program “h”.

The above equation (1) provides the following conditions. A calculation-object keyword “k” appearing in connection with a broadcast program concerning a smaller number of keywords is assigned a higher importance to the user, and has a greater program-selection history appearance frequency Fk,h. On the other hand, a calculation-object keyword “k” appearing in connection with a broadcast program concerning a greater number of keywords is assigned a lower importance to the user, and has a smaller program-selection history appearance frequency Fk,h. The above equation (1) employs a logarithmic function in harmony with human sensations.

The step S306 computes a sum of the program-selection history appearance frequencies Fk,h of each calculation-object keyword “k” for all the broadcast programs “h” (h=1, 2, 3, . . . , h0) according to an equation expressed as:

$${F}_{k} = {\sum }_{h} {F}_{k , h} \qquad ( 2 )$$

The computed sum is defined as a final program-selection history appearance frequency Fk of each calculation-object keyword “k”.

A step S307 following the step S306 computes the degree Pk of user's preference for each calculation-object keyword “k” from the number N of the broadcast programs corresponding to all the program information pieces in the program-information storage device 102 (the storage device 150E), the keyword appearance program number Nk, and the final program-selection history appearance frequency Fk according to an equation given as:

$${P}_{k} = \frac{Fk}{{log}_{2} ( \frac{N}{{N}_{k}} + 1 )} \qquad ( 3 )$$

The above equation (3) provides the following conditions. A calculation-object keyword “k” appearing in connection with a greater number of broadcast programs is assigned a lower importance to the user, and has a smaller preference degree Pk. On the other hand, a calculation-object keyword “k” appearing in connection with a smaller number of broadcast programs is assigned a higher importance to the user, and has a greater preference degree Pk. The above equation (3) employs a logarithmic function in harmony with human sensations.

A step S308 subsequent to the step S307 decides whether or not information of a keyword-operation history is present in the history storage device 110 (the storage device 150E). When information of a keyword-operation history is present, the computer program advances from the step S308 to a step S309. Otherwise, the computer program jumps from the step S308 to a step S313.

The step S309 refers to the information of the keyword-operation history in the history storage device 110, and counts the number Sk of times each calculation-object keyword “k” has been chosen by the user. The counted number Sk is referred to as the choice number Sk.

A step S310 following the step S309 computes a non-choice frequency Gk of each calculation-object keyword “k”. Every keyword-choice picture has a prescribed number M of keywords. The step S310 considers past keyword-choice pictures each having keywords including a calculation-object keyword “k”. For each calculation-object keyword “k”, the step S310 counts the number Tk of times keywords other than the calculation-object keyword “k” have been chosen among keywords in the considered keyword-choice pictures. The step S310 calculates the non-choice frequency Gk of each calculation-object keyword “k” from the keyword number M and the counted number Tk according to an equation expressed as:

$${G}_{k} = \frac{{T}_{k}}{M - 1} \qquad ( 4 )$$

The above equation (4) means that the frequency-related value Tk is equally distributed among M−1 unchosen keywords in a keyword-choice picture as a non-choice frequency Gk per unchosen keyword.

A step S311 subsequent to the step S310 computes the degree Ik of user's interest in each calculation-object keyword “k” from the choice number Sk and the non-choice frequency Gk according to an equation given as:

$${I}_{k} = \frac{{S}_{k} - {G}_{k}}{Q} \qquad ( 5 )$$

where Q denotes the number of times of keyword operation which is mentioned in the keyword-operation history.

The above equation (5) means that the interest degree Ik increases as the choice number Sk increases, and that the interest degree Ik decreases as the non-choice frequency Gk increases. The interest degree Ik results from normalization responsive to the keyword operation number Q.

A step S312 following the step S311 corrects the preference degree Pk for each calculation-object keyword “k” in response to the interest degree Ik to obtain a corrected preference degree Rk according to an equation expressed as:
Rₖ=Pₖ+A•Iₖ•Pmax (6)
where Pmax denotes the maximum of the preference degrees P1, P2, P3, . . . , Pk0 for the respective calculation-object keywords or the maximum of selected ones of the preference degrees P1, P2, P3, . . . , Pk0 for the respective calculation-object keywords, and “A” denotes a preset constant for determining the degree of the correction responsive to the interest degree Ik. The degree of the correction increases and decreases as the constant “A” increases and decreases, respectively.

The above equation (6) means that the corrected preference degree Rk increases and decreases as the interest degree Ik increases and decreases respectively. In the above equation (6), the interest degree Ik, the constant “A”, and the maximum Pmax of the preference degrees P1, P2, P3, . . . , Pk0 are multiplied. Therefore, an optimal value for the constant “A” is roughly constant regardless of the distribution of the preference degrees P1, P2, P3, . . . , Pk0. Preferably, the constant “A” is preset to an optimal value decided through experiments.

The step S312 sets the variable Pk to the corrected preference degree Rk. Accordingly, the step S312 updates the preference degree Pk, which is computed by the step S307, into agreement with the corrected preference degree Rk. After the step S312, the computer program advances to the step S313.

The step S313 refers to the preference degrees P1, P2, P3, . . . , Pk0 for the respective calculation-object keywords which are equal to those computed by the step S307 or the corrected preference degrees R1, R2, R3, . . . , Rk0 obtained by the step S312. The step S313 compares the preference degrees P1, P2, P3, . . . , Pk0 for the respective calculation-object keywords to select high-preference-degree ones from the calculation-object keywords. Specifically, the step S313 arranges the calculation-object keywords in the order of preference degree. Then, the step S313 carries out keyword selection in the following way. Normally, a prescribed number of successive keywords starting from one with the highest preference degree are selected from the arranged calculation-object keywords. A keyword mentioned in the keyword-operation history as one to be deleted is not selected even though its preference degree is high. On the other hand, a keyword mentioned in the keyword-operation history as settled one is always selected even though its preference degree is low. The step S313 places the selected keywords in a keyword-choice picture. In more detail, the step S313 generates information of a keyword-choice picture having the selected keywords. The selected keywords are referred to as the preferred keywords.

A step S314 following the step S313 selects broadcast programs corresponding to program information pieces containing the preferred keywords by referring to the relation between the extracted keywords and the broadcast programs (the assignment of the broadcast programs to the extracted keywords). In other words, the step S314 detects broadcast programs assigned to the preferred keywords. Generally, the selected or detected broadcast programs are ones scheduled to be broadcasted in the future or ones which have been recorded. After the step S314, the current execution cycle of the computer program ends.

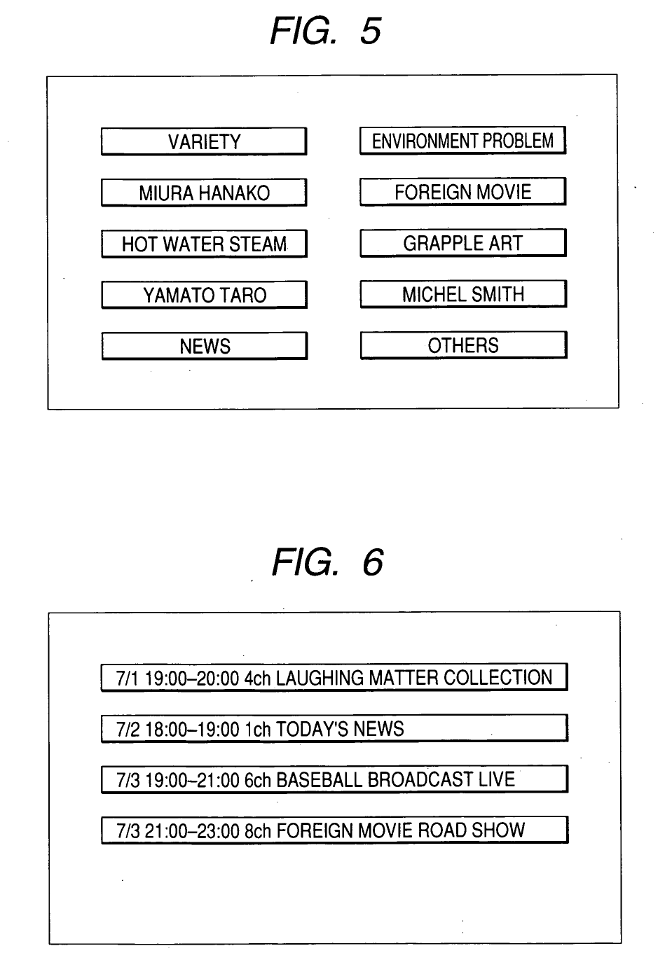

FIG. 5 shows an example of the keyword-choice picture displayed by the output device 112. With reference to FIG. 5, the keyword-choice picture has preferred keywords expressed by sequences of letters and characters. Preferably, the preferred keywords in the keyword-choice picture are arranged in the order of preference degree. The keyword-choice picture may further have a numeral denoting the number of broadcast programs corresponding to program information pieces containing each of the preferred keywords, and a numeral denoting the preference degree of each of the preferred keywords. In the presence of a broadcast program or programs assigned to none of the preferred keywords, there may be provided an item of “others” to which the broadcast program or programs are assigned.

Preferably, the keyword-choice picture has a cursor which can be moved in accordance with user's operation of the input device 114, and the input device 114 has a decision button. In this case, the user can move the cursor to desired one of the preferred keywords by operating the input device 114, and then choose the desired one among the preferred keywords by pressing the decision button of the input device 114. When the desired keyword is chosen, the keyword-choice picture displayed on the output device 112 is replaced by a program-selection picture. The program-selection picture has the names (the titles) of broadcast programs corresponding to program information pieces each containing the chosen keyword. Information of the choice of the desired keyword is generated as information of a keyword-operation history. The information of the keyword-operation history is stored into the history storage device 110 (the storage device 150E). Information of a keyword-operation history in the history storage device 110 may be updated in accordance with the information of the choice of the desired keyword.

Preferably, the input device 114 has a deletion button and a settlement button. In this case, the user can delete a keyword from a keyword-choice picture or settle a keyword in the keyword-choice picture by moving the cursor to the keyword through the operation of the input device 114 and by pressing the deletion button or the settlement button. As a keyword is deleted or settled, information of the deletion or the settlement is generated as information of a keyword-operation history. The information of the keyword-operation history is stored into the history storage device 110 (the storage device 150E). Information of a keyword-operation history in the history storage device 110 may be updated in accordance with the information of the keyword deletion or the keyword settlement.

FIG. 6 shows an example of the program-selection picture displayed by the output device 112. With reference to FIG. 6, the program-selection picture has a set of rectangles which forms a list of broadcast programs corresponding to program information pieces each containing a keyword chosen in the keyword-choice picture. The rectangles are assigned the broadcast programs, respectively. Each of the rectangles has the title (the name), the on-air time, and the on-air channel of the corresponding broadcast program. Preferably, the broadcast programs listed in the program-selection picture are arranged in the order of preference degree or on-air time.

The user can move the cursor to one of the rectangles in the program-selection picture, which corresponds to desired one of the broadcast programs, by operating the input device 114, and then choose the desired one among the broadcast programs by pressing the decision button of the input device 114. In the case where the chosen broadcast program is one scheduled to be broadcasted in the future, a recording reservation may be made concerning the chosen broadcast program or the program-selection picture displayed on the output device 112 may be replaced by the recording-reservation picture. In the case where the chosen broadcast program is recorded one, the chosen broadcast program may be played back or the picture-selection picture displayed on the output device 112 may be replaced by a picture for playback, deletion, and editing.

The preference degrees of television programs scheduled to be broadcasted in the future may be calculated. In this case, each of television programs with high preference degrees may be automatically recorded.

The computer programs in FIGS. 3 and 4 may be read out from a recording medium before being installed on the apparatus of FIG. 1 or FIG. 2. Alternatively, the computer programs may be downloaded into the apparatus of FIG. 1 or FIG. 2 via a communication network.

What is claimed is:

1. A program-selection facilitating apparatus comprising:
means for presenting ones among broadcast programs as selection-candidate programs to a user;
means for selecting one from the selection-candidate programs in accordance with a command from the user;
means for generating a program-selection history in response to the selection of one from the selection-candidate programs;
means for storing the program-selection history;
means for obtaining program information pieces corresponding to the broadcast programs respectively;
means for storing the obtained program information pieces;
means for extracting keywords from the stored program information pieces;
means for calculating degrees of user's preference for the extracted keywords respectively in response to the stored program-selection history;
means for comparing the calculated preference degrees of the extracted keywords, for arranging the extracted keywords in an order of calculated preference degree, and for selecting, among the arranged keywords, a prescribed number of successive keywords starting from one having a highest calculated preference degree as preferred keywords;
means for presenting the preferred keywords to the user;
means for choosing one among the preferred keywords in accordance with a command from the user;
means for extracting ones from the stored program information pieces, the extracted program information pieces containing the preferred keywords;
means for assigning the preferred keywords the broadcast programs corresponding to the extracted program information pieces;
means for detecting the broadcast programs which are assigned to the chosen preferred keyword as selection-candidate programs;
means for presenting, to the user, at least portions of the program information pieces corresponding to the selection-candidate programs;
means for generating a keyword-operation history in response to the choice of one among the preferred keywords;
means for storing the generated keyword-operation history;
means for calculating degrees of user's interest in the extracted keywords respectively from the stored keyword-operation history;
means for updating the calculated preference degrees of the extracted keywords to generate new calculated preference degrees of the extracted keywords in response to the calculated interest degrees of the extracted keywords;
means for comparing the new calculated preference degrees of the extracted keywords, for arranging the extracted keywords in an order of new calculated preference degree, and for selecting, among the arranged keywords, a prescribed number of successive keywords starting from one having a highest new calculated preference degree as new preferred keywords;
means for presenting the new preferred keywords to the user; and
means for choosing one among the new preferred keywords in accordance with a command from the user.

2. A program-selection facilitating method comprising the steps of:
presenting ones among broadcast programs as selection-candidate programs to a user;
selecting one from the selection-candidate programs in accordance with a command from the user;
generating a program-selection history in response to the selection of one from the selection-candidate programs;
storing the program-selection history;
obtaining program information pieces corresponding to the broadcast programs respectively;
storing the obtained program information pieces;
extracting keywords from the stored program information pieces;
calculating degrees of user's preference for the extracted keywords respectively in response to the stored program-selection history;
comparing the calculated preference degrees of the extracted keywords, arranging the extracted keywords in an order of calculated preference degree, and selecting, among the arranged keywords, a prescribed number of successive keywords starting from one having a highest calculated preference degree as preferred keywords;
presenting the preferred keywords to the user;
choosing one among the preferred keywords in accordance with a command from the user;
extracting ones from the stored program information pieces, the extracted program information pieces containing the preferred keywords;
assigning the preferred keywords the broadcast programs corresponding to the extracted program information pieces;
detecting the broadcast programs which are assigned to the chosen preferred keyword as selection-candidate programs;
presenting, to the user, at least portions of the program information pieces corresponding to the selection-candidate programs;
generating a keyword-operation history in response to the choice of one among the preferred keywords;
storing the generated keyword-operation history;
calculating degrees of user's interest in the extracted keywords respectively from the stored keyword-operation history;
updating the calculated preference degrees of the extracted keywords to generate new calculated preference degrees of the extracted keywords in response to the calculated interest degrees of the extracted keywords;
comparing the new calculated preference degrees of the extracted keywords, arranging the extracted keywords in an order of new calculated preference degree, and selecting, among the arranged keywords, a prescribed number of successive keywords starting from one having a highest new calculated preference degree as new preferred keywords;
presenting the new preferred keywords to the user; and
choosing one among the new preferred keywords in accordance with a command from the user.

3. A computer program for facilitating the selection of broadcast programs by a user, comprising the steps of:
presenting ones among broadcast programs as selection-candidate programs to a user;
selecting one from the selection-candidate programs in accordance with a command from the user;
generating a program-selection history in response to the selection of one from the selection-candidate programs;
storing the program-selection history;
obtaining program information pieces corresponding to the broadcast programs respectively;
storing the obtained program information pieces;
extracting keywords from the stored program information pieces;
calculating degrees of user's preference for the extracted keywords respectively in response to the stored program-selection history;
comparing the calculated preference degrees of the extracted keywords, arranging the extracted keywords in an order of calculated preference degree, and selecting, among the arranged keywords, a prescribed number of successive keywords starting from one having a highest calculated preference degree as preferred keywords;
presenting the preferred keywords to the user;
choosing one among the preferred keywords in accordance with a command from the user;
extracting ones from the stored program information pieces, the extracted program information pieces containing the preferred keywords;
assigning the preferred keywords the broadcast programs corresponding to the extracted program information pieces;
detecting the broadcast programs which are assigned to the chosen preferred keyword as selection-candidate programs;
presenting, to the user, at least portions of the program information pieces corresponding to the selection-candidate programs;
generating a keyword-operation history in response to the choice of one among the preferred keywords;
storing the generated keyword-operation history;
calculating degrees of user's interest in the extracted keywords respectively from the stored keyword-operation history;
updating the calculated preference degrees of the extracted keywords to generate new calculated preference degrees of the extracted keywords in response to the calculated interest degrees of the extracted keywords;
comparing the new calculated preference degrees of the extracted keywords, arranging the extracted keywords in an order of new calculated preference degree, and selecting, among the arranged keywords, a prescribed number of successive keywords starting from one having a highest new calculated preference degree as new preferred keywords;
presenting the new preferred keywords to the user; and
choosing one among the new preferred keywords in accordance with a command from the user.
